(19) United States
(12) Patent Application Publication
(10) Pub. No.: US 2026/0327354 A1
(43) Pub. Date: Oct. 22, 2026

(54) METHODS FOR PRODUCING VINYLAMINE-CONTAINING POLYMER SOLUTIONS INCLUDING ADDITION OF ALDEHYDE ACCEPTOR AND VINYLAMINE-CONTAINING POLYMER SOLUTIONS PRODUCED THROUGH THE METHODS

(71) Applicant: SOLENIS TECHNOLOGIES, L.P., Wilmington, DE (US)

(72) Inventors: Sachin Borkar, Wilmington, DE (US); Richard J. Riehle, Wilmington, DE (US)

(73) Assignee: SOLENIS TECHNOLOGIES, L.P., Wilmington, DE (US)

(21) Appl. No.: 19/462,075

(22) Filed: Jan. 28, 2026

Related U.S. Application Data
(60) Provisional application No. 63/750,852, filed on Jan. 29, 2025.

(51) Int. Cl. C08F 8/12

(52) U.S. Cl. CPC C08F 8/12

(57) ABSTRACT

Methods for producing a vinylamine-containing polymer solution, and vinylamine-containing polymer solutions produced through the methods, are provided herein. In an embodiment, a method for producing a vinylamine-containing polymer solution includes polymerizing N-vinylcarboxamide monomers, adding an aldehyde acceptor, and hydrolyzing a resulting intermediate polymer formulation. The aldehyde acceptor is added in an amount of from greater than 1.0% to about 3.0% by weight, based on the amount of N-vinylcarboxamide monomers added to the reaction mixture.

### CROSS-REFERENCE TO RELATED APPLICATIONS

This application claims the benefit of U.S. Provisional Application No. 63/750,852, filed Jan. 29, 2025, the entire contents of which are hereby incorporated by reference.

### TECHNICAL FIELD

The present disclosure generally relates to polymer production, and more particularly relates to polymerization of N-vinylcarboxamide monomers.

### BACKGROUND

Vinylamine-containing polymers are synthetic polymers that contain vinylamine units in their chemical structure. Vinylamine-containing polymers are cationic in nature. They are also highly water soluble, which makes them suitable for use in aqueous solutions. Vinylamine-containing polymers are generally stable under a wide range of pH conditions, temperature, and exposure to oxygen. They can form films and coatings when applied to surfaces. These properties make vinylamine-containing polymers useful in various applications including papermaking, water treatment, and adhesives and coatings.

One example of a vinylamine-containing polymer is polyvinylamine (PVAm). PVAm is a polymer having a high content of primary amine functional groups. As a result, PVAm can form hydrogen and/or covalent bonds with functional surfaces or molecules, and it readily creates derivatives. PVAm adsorbs on most surfaces in water, generating cationic interfaces which can form complexes with oppositely charged polymers or molecules, including negatively charged surfactants. PVAm is very hydrophilic. Because PVAm derivatives promote adhesion between wet or dry surfaces, PVAm is used as a papermaking additive.

The general processes for synthesizing vinylamine-containing polymers are known in the industry. In one process, first, N-vinylcarboxamide monomers (e.g., vinylformamide (VFA)) are combined with a polymerization initiator to create an intermediate polymer formulation containing a poly(N-vinylcarboxamide) prepolymer (e.g., polyvinylformamide (poly-VFA) prepolymer).

After the polymerization step is completed, acid or base is added to the resulting intermediate polymer formulation to hydrolyze the poly(N-vinylcarboxamide) prepolymer and create a polymer solution containing a vinylamine-containing polymer. The hydrolysis step converts carboxamide functions in the poly(N-vinylcarboxamide) prepolymer into vinylamine functions.

Sometimes an N-vinylcarboxamide monomer source contains impurities prior to the polymerization step. For example, some of the monomers may have unintentionally hydrolyzed in situ to form aldehydes, ketones, carboxamides, or other impurities. These impurities remain during the polymerization process. Further, during the polymerization process, the degree of polymerization is generally less than 100%. Accordingly, there are some residual N-vinylcarboxamide monomers remaining in the intermediate polymer formulation. These residual monomers are also known to decompose to form aldehydes, ketones, and other byproducts during the polymerization process and the ensuing hydrolysis process. Some of these residual monomers and byproducts are distilled off during the polymerization step or the hydrolysis step, but some remain and cause problems.

Byproducts such as aldehydes and ketones are polymerization inhibitors, which may inhibit the polymerization of the remaining N-vinylcarboxamide monomers. Further, any leftover unreacted N-vinylcarboxamide monomers and byproducts such as aldehydes or ketones that are present in the intermediate polymer formulation can cause problems during downstream process steps, such as during the hydrolysis step. Specifically, these impurities may react with functional groups in the vinylamine-containing polymer, which may cause crosslinking of the polymer before, during, or after the hydrolysis step. This crosslinking may cause an undesirable increase in dynamic viscosity of the vinylamine-containing polymer solution produced through the process, and it can even cause gelling of the solution.

In some existing processes for producing vinylamine-containing polymer solutions, an aldehyde acceptor may be added before or during the hydrolysis step. The aldehyde acceptor reacts with at least some of the aldehydes or ketones present in the intermediate polymer formulation to effectively bind the reactive sites of the aldehydes or ketones, preventing the aldehydes and ketones from reacting with the polymer to form crosslinks. The aldehyde acceptor may also react with residual N-vinylcarboxamide monomers. However, current practices involving addition of aldehyde acceptor are deficient in that excessive aldehyde often remains and the aldehyde acceptor can, itself, lead to poor properties of the vinylamine-containing polymer solution.

Accordingly, it is desirable to provide a method of synthesizing a vinylamine-containing polymer solution with reduced amounts of residual monomers and their byproducts present in the intermediate polymer formulation and during the hydrolysis step (and thus reduce crosslinking enough to prevent gelling), while limiting deleterious impacts of the aldehyde acceptor on properties of the vinylamine-containing polymer solution. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Methods for producing a vinylamine-containing polymer solution, and vinylamine-containing polymer solutions produced through the methods, are provided herein. In an embodiment, a method for producing a vinylamine-containing polymer solution includes polymerizing N-vinylcarboxamide monomers, adding an aldehyde acceptor, and hydrolyzing a resulting intermediate polymer formulation.

The method comprises the polymerization of a reaction mixture that includes a polymerization initiator and one or more N-vinylcarboxamide monomers of Formula I:

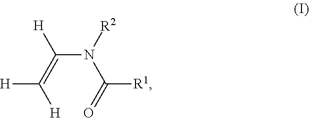

wherein R¹ and R², independently of one another, are H or C₁ to C₆ alkyl groups. Optionally, one or more vinyl monomers having a formula different from formula I may also be added to the reaction mixture. The polymerization step results in an intermediate polymer formulation which contains a poly(N-vinylcarboxamide) prepolymer. Aldehyde acceptor is added in an amount of from greater than 1.0% to about 3.0% by weight, based on the amount of N-vinylcarboxamide monomers present in the reaction mixture. Carboxamide groups in the poly(N-vinylcarboxamide) prepolymer are hydrolyzed during a hydrolysis step, resulting in a vinylamine-containing polymer solution which contains a vinylamine-containing polymer.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

The methods as provided herein enable production of a vinylamine-containing polymer solution with minimized crosslinking attributed to the presence of aldehydes and/or ketones (and thus minimized dynamic viscosity and gelling), while also minimizing deleterious effects of aldehyde acceptors on properties of the vinylamine-containing polymer solution. In particular, it has been found that high amounts of aldehyde acceptor present during formation of the vinylamine-containing polymer solution may lead to degradation of the vinylamine-containing polymer, excessive amounts of salt present in the vinylamine-containing polymer solution, and offensive odor of the vinylamine-containing polymer solution. The disclosed methods contemplate addition of an amount of an aldehyde acceptor that is higher than the conventional amount and thus binds the reactive sites of a higher percentage of the byproducts, reducing crosslinking. At the same time, the amount of aldehyde acceptor added through the methods is not so high that the aldehyde acceptor itself causes excessive degradation of the vinylamine-containing polymer, production of an excessive amount of salt, or excessive production of byproducts having an undesirable odor. An amount of aldehyde acceptor which achieves both these objectives has not previously been known in the field of vinylamine-containing polymer production. Through the methods contemplated herein, vinylamine-containing polymer solutions may be produced from sources of vinylcarboxamide monomers that may have previously been considered unacceptable.

Unless specifically stated or obvious from context, as used herein, the term “about” is understood as within a range of normal tolerance in the art measured using standard measurement devices, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The methods as provided herein are directed to synthesis of a polymer product. The methods include reacting a polymerization initiator with one or more N-vinylcarboxamide monomers and optionally one or more additional vinyl monomers to form a poly(N-vinylcarboxamide) prepolymer, adding an aldehyde acceptor in an amount of from greater than 1.0% to about 3.0% by weight, based on the amount of N-vinylcarboxamide monomers added to the reaction mixture, and hydrolyzing carboxamide groups in the poly(N-vinylcarboxamide) prepolymer to form a vinylamine-containing polymer solution.

The methods first involve a polymerization step in which one or more N-vinylcarboxamide monomers is provided having the formula I:

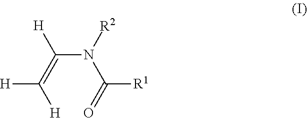

wherein R¹ and R², independently of one another, are H or C₁ to C₆ alkyl groups. The monomer(s) of formula I are combined with a polymerization initiator in a reaction mixture under appropriate reaction conditions to effectuate a polymerization reaction and produce an intermediate polymer formulation comprising a poly(N-vinylcarboxamide) prepolymer. The “polymerization step,” is defined as the overt step of combining the polymerization initiator and one or more N-vinylcarboxamide monomers, and optionally one or more other vinyl monomers, under reaction conditions to form the intermediate polymer formulation comprising the poly(N-vinylcarboxamide) prepolymer. Polymerization of residual monomers, impurities, or unintentional reaction products of monomers may also occur incidentally before the polymerization step. This incidental polymerization is not considered part of the “polymerization step.”

Various vinylcarboxamide monomers having formula I may be employed in accordance with the present disclosure. For example, in some embodiments, if R¹ and R² are both H, then the N-vinylcarboxamide monomer of formula I is N-vinylformamide. In other embodiments, if R¹ and R² are both methyl groups, then the N-vinylcarboxamide monomer having the formula I is N-vinyl-N-methylacetamide. In still other embodiments, R¹ and R² may be two different functional groups. Other examples of N-vinylcarboxamide monomers include but are not limited to N-vinyl-N-methylformamide, N-vinylacetamide, N-vinyl-N-ethylacetamide, N-vinylpropionamide, N-vinyl-N-methyl-propionamide, and N-vinylbutyramide. One or more variations of monomers having formula I are reactants in the claimed methods.

In embodiments, the source of N-vinylcarboxamide monomers may have an N-vinylcarboxamide content of less than about 97%, alternatively less than about 95%, alternatively less than about 87%, alternatively from about 87% to about 97%, alternatively from about 87% to about 93%, alternatively from about 94% to about 97%, by weight based on a total weight of the source of N-vinylcarboxamide monomers.

Providing a source of N-vinylcarboxamide monomers having an N-vinylcarboxamide content as described in the previous paragraph is significant because such a source of N-vinylcarboxamide monomers may not be usable to produce an acceptable polymer solution through a conventional synthesis process. However, the methods as provided herein allow for use of a source of N-vinylcarboxamide monomers having an N-vinylcarboxamide content below 97% to produce an acceptable polymer solution owing to the amounts of aldehyde acceptor that are employed in accordance with the methods contemplated herein as compared to conventional amounts. As used herein, an “acceptable” vinylamine-containing polymer solution refers to a vinylamine-containing polymer solution which is deemed to be usable for its intended purpose. An “acceptable” polymer solution exhibits excellent properties which make the polymer solution desirable for use in, for example, a papermaking process or water purification process.

In some embodiments, one or more vinyl monomers of a formula different from formula I may also be reactants. “Vinyl monomer(s)” refers to monomer(s) which have (H₂C═C—) group in their structure. Vinyl monomers could alternatively be defined as ethylenically unsaturated monomers. Examples of suitable vinyl monomers having a formula different from formula I include, but are not limited to, N-vinylpyrrolidone, acrylamide, acrylic acid, vinyl acetate, methyl acrylate, or combinations thereof. Additional examples include, but are not limited to, methacrylamide, N-isopropylacrylamide, N-methylmethacrylamide, acrylonitrile, vinyl chloride, styrene, methacrylic acid, vinylphosphonic acid, vinylsulfonic acid, maleic acid, itaconic acid, diallyldimethylammonium chloride (DADMAC), acrylamidopropyltrimethyl ammonium chloride (APTAC), methacrylamidopropyltrimethyl ammonium chloride, or combinations thereof. Any combination of the aforementioned monomers may be used.

The polymerization initiator may be a non-oxidizing radical initiator, such as an azo compound. Examples of azo initiators include, but are not limited to, 2,2′-azobis(2-methylpropionamidine)dihydrochloride (which is available commercially from FUJIFILM Wako Chemicals USA, Corp. under the trade name V-50) 2,2′-azobis(2-amidinopropane)dihydrochloride, 2,2′-azobis(N,N′-dimethyleneisobutyramidine)dihydrochloride, 2,2′-azobis[2-methyl-N-(2-hydroxyethyl)-propionamide], azo-bis-isobutyronitrile, 4,4′-azobis(4-cyanovaleric acid), 2,2′-azobis[2-(2-imidazolin-2-yl)propane]dihydrochloride, 2,2′-azobis[N-(2-carboxyethyl)-2-methylpropionamidine]tetrahydrate, or 2-2′-azobis(2-methyl-butyronitrile). In other embodiments, the polymerization initiator may be hydrogen peroxide, alkali metal or ammonium salts of peroxydisulfuric acid, peroxides, hydroperoxides, or redox catalysts. In some embodiments, the polymerization initiator may be used in an amount from about 0.01 to about 5% by weight, based on the total weight of the reaction mixture.

It is to be appreciated that any or all of the components above (e.g. monomers, modifiers, etc.) may be prepared or otherwise obtained (e.g. from commercial sources). Moreover, such components and/or the reagents used to prepare the same may originate from traditional (e.g. fossil-based) sources, or instead may be bio-based, i.e., prepared using biological methods and/or from products of such methods. In some embodiments, the method utilizes all bio-based components in the preparation of the vinylamine containing polymers. In other embodiments, at least a portion of a component is bio-based.

The reaction mixture may be an aqueous solution of at least about 30% monomers by weight based on the total weight of the reaction mixture. The concentration of the monomers in the aqueous solution may be up to about 90% by weight, alternatively from about 60% to about 85% by weight, based on the total weight of the reaction mixture.

The reaction mixture may be buffered to a pH of from about 5 to about 8, alternatively from about 6 to about 7. To stabilize the pH during the polymerization step, the polymerization step may be carried out in the presence of a conventional buffer system.

The polymerization step may also be carried out under an inert gas, such as nitrogen, or under vacuum. In other embodiments, the polymerization step may be carried out with evaporative cooling at from 20 mbar to atmospheric pressure and a temperature in the reaction mixture of less than about 100° C., alternatively from about 25° C. to about 80° C.

In some embodiments, the polymerization step may be carried out in a mixing apparatus in which the reactants can be thoroughly mixed. For example, the polymerization step may be carried out in a single-screw kneader or an extruder. The solids content of the reaction mixture during the polymerization step may be from about 30% to about 90% by weight, alternatively from about 60% to about 85% by weight, based on the total weight of the reaction mixture.

After the polymerization step, in some embodiments, the conversion of the monomers into a polymer may be at least 75 mol %, based on the total moles of monomers present in the reaction mixture prior to polymerization. In other embodiments, the conversion of monomers into a polymer may be lower than 75 mol %, based on the total moles of monomers present in the reaction mixture prior to polymerization. The lower the conversion rate of monomers into a polymer, the higher the amount of unreacted N-vinylcarboxamide monomers present in the intermediate polymer formulation.

After the polymerization step has been completed, an intermediate polymer formulation has been formed. As used herein, an intermediate polymer formulation is defined as a polymer formulation which contains a poly(N-vinylcarboxamide) prepolymer. The intermediate polymer formulation may also contain other polymers, unreacted N-vinylcarboxamide monomers, residual polymerization initiator, or other byproducts or impurities. Impurities present in the intermediate polymer formulation may include aldehydes and ketones, which may have been present in the N-vinylcarboxamide monomer source or may be the result of incidental hydrolysis of unreacted N-vinylcarboxamide monomers present in the intermediate polymer formulation. Aldehydes and ketones present in the intermediate polymer formulation may react with the formed polymer, resulting in undesirable crosslinking. A poly(N-vinylcarboxamide) prepolymer is defined as a poly(N-vinylcarboxamide) polymer which has been formed through a polymerization step but has not yet been intentionally hydrolyzed, through addition of acid or base, to form a vinylamine-containing polymer solution. The poly(N-vinylcarboxamide) prepolymer may be a homopolymer or a copolymer and may contain non-vinylcarboxamide units derived from one or more vinyl monomers of a formula different from formula I as described above. In an embodiment, the N-vinylcarboxamide monomer reacted in the polymerization step is N-vinylformamide and the poly(N-vinylcarboxamide) prepolymer is a polyvinylformamide polymer. In some embodiments of the method, the poly(N-vinylcarboxamide) prepolymer has a molecular weight in the range of from about 5,000 Daltons to about 5,000,000 Daltons.

As previously described, the intermediate polymer formulation containing poly(N-vinylcarboxamide) prepolymer is the intermediate product in a method of forming a vinylamine-containing polymer solution. As used herein, unreacted N-vinylcarboxamide monomers are defined as N-vinylcarboxamide monomers which were combined with a polymerization initiator in a reaction mixture, but did not react to form the poly(N-vinylcarboxamide) prepolymer, and remain as monomers in the intermediate polymer formulation.

The degree of polymerization of monomers during the polymerization step is an important factor that affects properties of the resulting vinylamine-containing polymer solution. Any residual N-vinylcarboxamide monomers, or byproducts thereof, present after the polymerization step may cause problems during the downstream process steps, such as a hydrolysis step. Byproducts of the unreacted N-vinylcarboxamide monomers may include aldehydes and ketones. Aldehydes and ketones may also be present that were initially present in the reaction mixture prior to polymerization, i.e., that are not byproducts of the unreacted N-vinylcarboxamide monomers. In embodiments, the intermediate polymer formulation may have a content of aldehydes and ketones of from about 0.075% to about 0.25%, alternatively from about 0.125% to about 0.25%, alternatively from about 0.10% to about 0.20%, by weight based on the amount of N-vinylcarboxamide monomers added to the reaction mixture. The methods as provided herein provide for remediation of some of the unreacted monomers and byproducts to prevent associated problems.

The methods as provided herein also include a “hydrolysis step,” which is defined as the overt step of intentionally hydrolyzing functional groups in the poly(N-vinylcarboxamide) prepolymer contained in the intermediate polymer formulation to produce a vinylamine-containing polymer contained in a vinylamine-containing polymer solution. Hydrolysis of monomers, polymers, and other compounds that are present may also occur before the hydrolysis step. This incidental hydrolysis is not considered part of the “hydrolysis step.”

In some embodiments, the hydrolysis step includes hydrolyzing the poly(N-vinylcarboxamide) prepolymer in the intermediate polymer formulation by adding one or more acids or bases to produce the vinylamine-containing polymer solution including vinylamine-containing polymer. Examples of acids which may be used for the hydrolysis step include mineral acids or organic acids. Examples of bases which may be used for the hydrolysis step include lithium hydroxide, sodium hydroxide, potassium hydroxide, calcium hydroxide, strontium hydroxide, and/or barium hydroxide.

In some embodiments, the acid or base may be added to the reaction mixture in the hydrolysis step in an amount of from about 0.05 to about 1.5, alternatively from about 0.4 to about 1.2, equivalents of base or acid per equivalent of formyl groups in the polymer. The hydrolysis step may be carried out at a temperature in the reaction mixture of from about 20° C. to about 100° C., alternatively from about 40° C. to about 70° C.

As used herein, a vinylamine-containing polymer is defined as a polymer containing vinylamine functional groups, which has been formed through a polymerization step and a hydrolysis step. The vinylamine-containing polymer may be a homopolymer or a copolymer and may contain non-vinylamine units. A vinylamine-containing polymer solution is defined as a polymer formulation which contains at least a vinylamine-containing polymer. It may also contain other polymers, unreacted N-vinylcarboxamide monomers, unreacted vinyl monomers having a formula different from formula I, residual polymerization initiator, or other byproducts or impurities. Notably, residual N-vinylcarboxamide monomers or their hydrolysis products may still be present in the vinylamine-containing polymer solution.

In embodiments, the vinylamine-containing polymer solution may have a dynamic viscosity of less than about 4000 cPs, alternatively less than about 2700 cPs, alternatively less than about 2500 cPs, alternatively less than about 1650 cPs, alternatively from about 1000 cPs to about 2000 cPs, as measured with total solids of 21%, using a Brookfield viscometer at 6 rpm using an LV spindle number 62 at 25° C.

In one particular embodiment, the vinylamine-containing polymer solution is formed from an intermediate polymer formulation having a content of aldehydes and ketones of from about 0.075% to about 0.25%, alternatively from about 0.125% to about 0.25%, alternatively from about 0.1% to about 0.2%, by weight based on the amount of N-vinylcarboxamide monomers added to the reaction mixture, and the vinylamine-containing polymer has a dynamic viscosity of from about 1000 cPs to about 2000 cPs, as measured with total solids of 21%, using a Brookfield viscometer at 6 rpm using an LV spindle number 62 at 25° C. In this embodiment, the vinylamine-containing polymer solution is formed from an intermediate polymer formulation which may have previously been unusable to form an acceptable vinylamine-containing polymer solution because of the relatively high amount of aldehydes and ketones present in the intermediate polymer formulation. However, as will be described in more detail below, the claimed process allows for use of such an intermediate polymer formulation to produce a vinylamine-containing polymer solution with an acceptable dynamic viscosity due to the amount of aldehyde acceptor used in accordance with the methods contemplated herein.

In embodiments, the vinylamine-containing polymer solution may undergo a dynamic viscosity change of less than about 1000 cPs, alternatively less than about 300 cPs, alternatively from about 10 cPs to about 700 cPs, when stored over a period of 42 days in an environment having a temperature of about 50° C. Minimized viscosity change of the vinylamine-containing polymer solution over time is desirable because it allows the vinylamine-containing polymer solution to be usable for its intended purpose after extended periods of storage or transportation.

After the hydrolysis step has been completed, the resulting vinylamine-containing polymer may be the result of either complete hydrolysis of the poly(N-vinylcarboxamide) prepolymer or partial hydrolysis of the poly(N-vinylcarboxamide) prepolymer. In an embodiment, if complete hydrolysis has occurred, then substantially every carboxamide moiety contained in the poly(N-vinylcarboxamide) prepolymer has been hydrolyzed to form the resulting vinylamine-containing polymer. This results in the vinylamine-containing polymer containing hydrolysis products of the carboxamide moieties present in the prepolymer.

In other embodiments, complete hydrolysis may not have occurred. The degree of hydrolysis of the carboxamide moieties contained in the poly(N-vinylcarboxamide) prepolymer may be from about 0.1 mol % to less than about 99 mol %, alternatively from about 10 mol % to about 90 mol %, alternatively from about 40 mol % to about 80 mol %, alternatively from about 60 mol % to about 70 mol %, based on the total moles of carboxamide moieties in the prepolymer.

In addition to the vinylamine-containing homopolymer or copolymer, the vinylamine-containing polymer solution may contain other polymers, unreacted N-vinylcarboxamide monomers, other unreacted vinyl monomers, residual polymerization initiator, or other byproducts or impurities. Impurities present in the intermediate polymer formulation may include aldehydes and ketones, which may have been present in the N-vinylcarboxamide monomer source or may be the result of incidental hydrolysis of unreacted N-vinylcarboxamide monomers present in the intermediate polymer formulation or during the hydrolysis step.

Accordingly, impurities in the intermediate polymer formulation may lead to problems during the hydrolysis step, which in turn may lead to a lower quality vinylamine-containing polymer solution. Specifically, it has been found that the presence of unreacted N-vinylcarboxamide monomers in the intermediate polymer formulation leads to a lower quality vinylamine-containing polymer solution after the hydrolysis step. Without being bound by any theory, this is thought to be a result of unintentional conversion of the unreacted N-vinylcarboxamide monomers to their hydrolysis byproducts (e.g. aldehydes and ketones) before or during the hydrolysis step. The presence of these byproducts may cause crosslinking of the vinylamine-containing polymer or other undesirable side reactions.

In order to improve the quality of the vinylamine-containing polymer solution, it is desirable to minimize the amount of aldehydes and ketones present in the intermediate polymer formulation and during the hydrolysis step. Accordingly, the methods provided herein provide for the addition of an aldehyde acceptor, before or during the hydrolysis step, in an amount of from greater than 1.0% to about 3.0% by weight, based on the total weight of N-vinylcarboxamide monomers added to the reaction mixture.

As used herein, the term “aldehyde acceptor” refers to a compound that is capable of reacting with the reactive site of an aldehyde or ketone. An aldehyde acceptor may react with an aldehyde or ketone to form an adduct, binding the reactive site and preventing the aldehyde or ketone from reacting with anything else. Nonlimiting examples of aldehyde acceptors include reducing compounds such as sulfite salt, bisulfite salt, sulfur dioxide, dithionite salt, hydroxylamine, or phenylhydrazine. Other examples of aldehyde acceptors include but are not limited to urea, ethyleneurea, propyleneurea, melamine, guanidine, aminoguanidine, or mixtures thereof. In embodiments, the aldehyde acceptor is a bisulfite salt such as sodium bisulfite.

In embodiments, the aldehyde acceptor may be added in an amount of from greater than 1.0% to about 3.0%, alternatively from greater than 1.0% to about 2.5%, alternatively from greater than 1.0% to about 1.75%, alternatively from about 1.15% to about 1.35%, by weight based on the total weight of N-vinylcarboxamide monomers added to the reaction mixture.

Adding the aldehyde acceptor in the aforementioned amounts is effective to minimize crosslinking without causing deleterious effects on the resulting vinylamine-containing polymer solution. In particular, adding the aldehyde acceptor in the recited amounts allows the aldehyde acceptor to react with, and bind the reactive sites of, a sufficient amount of residual N-vinylcarboxamide monomers, aldehydes, and ketones to minimize crosslinking. By binding the reactive sites of residual N-vinylcarboxamide monomers, the aldehyde acceptor prevents the residual N-vinylcarboxamide monomers from decomposing to form aldehydes and ketones. By binding the reactive sites of the aldehydes and ketones present in the reaction mixture or intermediate polymer formulation, the aldehyde acceptor prevents the aldehydes and ketones from reacting with the polymer to cause crosslinking. If the aldehyde acceptor is added in too small of an amount, i.e. less than about 1.0% by weight based on the total weight of N-vinylcarboxamide monomers added to the reaction mixture, then the addition of the aldehyde acceptor may not be sufficient to inhibit excessive crosslinking. Excessive crosslinking leads to an unacceptably high increase in dynamic viscosity and gelling of the vinylamine-containing polymer solution.

At the same time, adding the aldehyde acceptor in the recited amounts has been found to prevent unwanted effects associated with excessive residual aldehyde acceptor. Specifically, if the aldehyde acceptor is added in an amount such that too much residual aldehyde acceptor remains after the reactive sites of the residual N-vinylcarboxamide monomers, aldehydes, and ketones have been bound, then the residual aldehyde acceptor may cause degradation of the vinylamine-containing polymer, reducing the quality of the polymer present in the vinylamine-containing polymer solution. Degradation of the vinylamine-containing polymer may manifest in an undesirable decrease in dynamic viscosity of the vinylamine-containing polymer solution. This may make the polymer solution unfit for its intended purpose. Further, if the aldehyde acceptor is in the form of a salt, then residual aldehyde acceptor may cause excessive amounts of salt to be present in the vinylamine-containing polymer solution. Reaction of the aldehyde acceptor with aldehydes, ketones, or other compounds may also produce byproducts which give off an offensive odor. For example, some aldehyde acceptors decompose to produce sulfur dioxide, which gives off an offensive odor. The odor is undesirable for customers who are in the market for the vinylamine-containing polymer solution. If the aldehyde acceptor is added in too high of an amount, i.e. greater than about 3.0% by weight, then the aforementioned deleterious effects are observed, resulting in a lower quality vinylamine-containing polymer solution.

In embodiments, the method step of adding an aldehyde acceptor in an amount of from greater than 1.0% to about 3.0% by weight based on the total weight of N-vinylcarboxamide monomers added to the reaction mixture includes measuring the amount of aldehydes, ketones, and unreacted N-vinylcarboxamide monomers in the intermediate polymer formulation, and adding an amount of aldehyde acceptor such that the ratio of aldehyde acceptor to aldehydes, ketones, and unreacted N-vinylcarboxamide monomers in the intermediate polymer formulation is a predetermined weight ratio. As used herein, a “predetermined weight ratio” is defined as a ratio of the weight of aldehyde acceptor added to the weight of aldehydes, ketones, and unreacted N-vinylcarboxamide monomers present in the intermediate polymer formulation. In embodiments, the predetermined weight ratio may be from about 0.5:1 to about 1.5:1, alternatively from about 0.8:1 to about 1.2:1, alternatively from about 0.9:1 to about 1.1:1.

Measuring the amount of aldehydes and ketones in the intermediate polymer formulation and adding an amount of aldehyde acceptor in accordance with a predetermined weight ratio ensures that the aldehyde acceptor is added in an amount sufficient to minimize crosslinking but not so high as to cause polymer degradation, excessive salt production, or offensive odors. It is thought that any aldehydes or ketones present in the intermediate polymer formulation act as crosslinkers before or during the hydrolysis step. Thus, it is desirable to bind the reactive sites of as many aldehydes and ketones as possible. Knowing the amount of aldehydes and ketones present in the intermediate polymer formulation allows for a calculation of the amount of aldehyde acceptor necessary to bind all the reactive sites. When this specific amount of aldehyde acceptor is added, it is enough to bind the reactive sites of the aldehydes and ketones without having excessive residual aldehyde acceptor leftover after the reactive sites are bound. Minimization of residual aldehyde acceptor minimizes polymer degradation, excessive salt production, and offensive odors.

### EXAMPLES

### Example 1

To a resin kettle equipped with overhead stirrer, thermocouple, condenser, nitrogen inlet-outlet, and pressure gauge was added 890 grams of deionized water, 2.4 grams of 75 wt % aqueous phosphoric acid, and 3.6 grams of 25 wt % aqueous sodium hydroxide. The resultant solution pH was adjusted to 6.5+/−0.3. The kettle was heated to 80° C. while stirring with overhead stirrer. The pressure was slowly lowered to about 320 torr.

N-vinylformamide (VFA, 180.4 grams), and 3.0 wt % aqueous V-50 (36.94 grams) initiator (available from Wako Chemicals USA, Inc., Richmond, USA) were added concurrently. The polymerization temperature was controlled at 78+/−2° C. After the V-50 addition was complete, the kettle vacuum was dropped to about 350 torr. After a total time of 240 minutes the vacuum was released, and the reactor was flushed with nitrogen (3 cycles of vacuum and nitrogen refill). After completion, the reactor was cooled to room temperature. The intermediate polymer formulation was separated into three batches.

To the first batch (Batch A), nothing additional was added (comparative example not in accordance with the present disclosure). To the second batch (Batch B), 1.7 grams of 38% sodium bisulfite was added (corresponding to about 1 wt % sodium bisulfite based on the total weight of N-vinylformamide monomers used in the reaction). To the third batch (Batch C), 3.4 grams of 38% sodium bisulfite was added (corresponding to about 2.1 wt % sodium bisulfite based on the total weight of N-vinylformamide monomers used in the reaction).

Batch A was divided into eight sub-batches, Batch B was divided into six sub-batches, and Batch C was divided into two sub-batches. Additional acetaldehyde was added to some of the sub-batches to reach the weight percentage shown in Table 1 of acetaldehyde present in the intermediate on the basis of the total amount of N-vinylformamide monomers added.

Then, 1 molar equivalent of caustic was added to each intermediate polymer formulation, in an environment having a temperature of 80° C., holding reaction for 3 hours to effectuate a hydrolysis reaction and form a vinyl amine-containing polymer formulation.

The dynamic viscosity of each resulting vinyl amine-containing polymer solution was measured with total solids of 210, using a Brookfield viscometer at 6 rpm using an LV spindle number 62 at 25° C. The results are shown in Table 1 below.

TABLE 1
Dynamic Viscosity of Vinylamine-Containing Polymer Solutions
Formed from Intermediate Polymer Formulations with Varying
Acetaldehyde Content Using Varying Amounts of Bisulfite

| Acetaldehyde | Weight Percent of | Dynamic |
|---|---|---|
| Content | Bisulfite Based on | Viscosity |
| (wt %) | VFA Monomers Added | (cPs) |
| 0 | 0% (comparative) | 1720 |
| 0.0089 | 0% (comparative) | 2020 |
| 0.025 | 0% (comparative) | 2359 |
| 0.035 | 0% (comparative) | 2529 |
| 0.05 | 0% (comparative) | 5589 |
| 0.075 | 0% (comparative) | 6409 |
| 0.088 | 0% (comparative) | Gelled |
| 0.1 | 0% (comparative) | Gelled |
| 0 | 1.0% | 962 |
| 0.075 | 1.0% | 1318 |
| 0.1 | 1.0% | 1176 |
| 0.125 | 1.0% | 1380 |
| 0.15 | 1.0% | Gelled |
| 0.2 | 1.0% | Gelled |
| 0.1 | 2.0% | 1190 |
| 0.2 | 2.0% | 1480 |

The results of Example 1 show that adding 1.0% bisulfite by weight based on the total weight of N-vinylformamide monomers added reduces the dynamic viscosity of the resulting vinylamine-containing polymer solution as compared to adding no bisulfite. The results also show that adding 2.0% bisulfite by weight based on the total weight of N-vinylformamide monomers added reduces the dynamic viscosity of the resulting vinylamine-containing polymer solution as compared to adding 1.0% bisulfite by weight based on the total weight of N-vinylformamide monomers added. When no bisulfite was added, the polymer solution gelled when the intermediate polymer formulation contained 0.088 wt % or more acetaldehyde. When 1.0 wt % bisulfite was added, the polymer solution gelled only when the intermediate polymer formulation contained 0.15 wt % or more acetaldehyde. When 2.0 wt % bisulfite was added, the polymer solution did not gel even when the intermediate polymer formulation contained 0.2 wt % acetaldehyde.

### Example 2

The procedure described in Example 1 for polymerization of N-vinylformamide monomers was performed using an N-vinylformamide monomer source having N-vinylformamide content of less than 95%. The intermediate poly(N-vinylformamide) polymer formulation was separated into seven batches.

Then, to a round bottom flask, equipped with an overhead stirrer, reflux condenser and thermocouple, was added 150 grams of the intermediate polymer formulation and the desired amount of 38 wt % sodium bisulfite solution, in order to reach a certain weight percentage of bisulfite based on the total weight of N-vinylformamide monomers added, as shown in Table 2 (from 0.75 wt % to 3.0 wt %). The reaction mixture was mixed with an overhead stirrer, and the temperature of the environment was increased to 80° C. Once the flask reached 80° C., 81.68 grams of sodium hydroxide solution was slowly added over a period of five minutes. The reaction environment was held at 80° C. for 3 hours. Then, the flask was cooled to 40° C., and the pH was adjusted to 7.5 by adding concentrated hydrochloric acid (HCl).

The dynamic viscosity of each resulting vinylamine-containing polymer solution was measured with total solids of 21%, using a Brookfield viscometer at 6 rpm using an LV spindle number 62 at 25° C. The results are shown in Table 2 below.

TABLE 2
Dynamic Viscosity of Vinylamine-Containing Polymer
Solutions with Addition of Varying Amounts of Bisulfite

| Weight Percent of Bisulfite Based | Dynamic |
|---|---|
| on VFA Monomers Added | Viscosity (cPs) |
| 0.75% | 3055 |
| 1.0% | 2740 |
| 1.25% | 2590 |
| 1.5% | 2205 |
| 1.75% | 2160 |
| 2.0% | 2465 |
| 3.0% | 2125 |

The results of Example 2 show that in general, incremental increases in the amount of sodium bisulfite added, from 0.5 wt % to 3.0 wt %, lead to a lower dynamic viscosity of the resulting vinylamine-containing polymer solution. An exception to the general trend is observed when 2.0 wt % of sodium bisulfite is added.

### Example 3

Each vinylamine-containing polymer solution produced in Example 2 was subjected to an aging study in which each vinylamine-containing polymer solution was stored in an environment having a temperature of 50° C. for 42 days. The dynamic viscosity of each vinylamine-containing polymer solution was then measured again in the same manner in which it was measured before the aging study. The change in dynamic viscosity of each vinylamine-containing polymer solution over the course of the aging study was calculated. The results are shown in Table 3 below.

TABLE 3
Change in Dynamic Viscosity Over Time

| Weight Percent of | Dynamic | |
|---|---|---|
| Sodium Bisulfite | Viscosity | Dynamic |
| Based on VFA | on Day | Viscosity |
| Monomers Added | 0 (cPs) | on Day 42 (cPs) |
| 0.75% | 3055 | 3254 |
| 1.00% | 2740 | 3924 |
| 1.25% | 2590 | 2629 |
| 1.50% | 2205 | 2954 |
| 1.75% | 2160 | 2994 |
| 2.00% | 2465 | 2369 |
| 3.00% | 2125 | 2305 |

The results of Example 3 demonstrate that adding about 1.25% bisulfite by weight, based on the total weight of N-vinylformamide monomers added, leads to a vinylamine-containing polymer having the smallest change in dynamic viscosity over time.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A method of synthesizing a vinylamine-containing polymer solution, the method comprising the steps of:
(a) reacting a polymerization initiator, one or more N-vinylcarboxamide monomers, and optionally one or more additional vinyl monomers having a formula different from the N-vinylcarboxamide monomers, in a reaction mixture to create an intermediate polymer formulation comprising a poly(N-vinylcarboxamide) prepolymer, wherein the N-vinylcarboxamide monomers have the general formula I 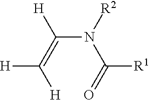
wherein R¹ and R², independently of one another, are H or C₁ to C₆ alkyl groups;
(b) adding an aldehyde acceptor in an amount of from greater than 1.0% to about 3.0% by weight based on the amount of N-vinylcarboxamide monomers present in the reaction mixture in step (a); and
(c) hydrolyzing carboxamide groups in the poly(N-vinylcarboxamide) prepolymer to create a vinylamine-containing polymer solution comprising a vinylamine-containing polymer.

2. The method of claim 1, wherein step (c) comprises creating a vinylamine-containing polymer solution having a dynamic viscosity of less than about 4000 cPs, as measured with total solids of 21%, using a Brookfield viscometer at 6 rpm using an LV spindle number 62 at 25° C.

3. The method of claim 1, wherein step (c) comprises creating a vinylamine-containing polymer solution having a dynamic viscosity of less than about 2500 cPs, as measured with total solids of 21%, using a Brookfield viscometer at 6 rpm using an LV spindle number 62 at 25° C.

4. The method of claim 1, wherein step (a) comprises combining a polymerization initiator, a source of N-vinylcarboxamide monomers, and optionally a source of one or more additional vinyl monomers, wherein the source of N-vinylcarboxamide monomers has an N-vinylcarboxamide content of less than about 97% by weight based on a total weight of the source of N-vinylcarboxamide monomers.

5. The method of claim 1, where step (c) comprises creating a vinylamine-containing polymer solution that undergoes a dynamic viscosity change of less than about 1000 cPs over a period of 42 days at a temperature of 50° C.

6. The method of claim 1, wherein step (c) comprises creating a vinylamine-containing polymer solution that undergoes a dynamic viscosity change of less than about 300 cPs over a period of 42 days at a temperature of 50° C.

7. The method of claim 1, wherein step (b) comprises adding the aldehyde acceptor to an intermediate polymer formulation having a content of aldehydes and ketones of from about 0.075% to about 0.25% by weight based on the amount of N-vinylcarboxamide monomers used in step (a), and wherein step (c) creates a vinylamine-containing polymer solution having a dynamic viscosity of from about 1000 cPs to about 2000 cPs, as measured with total solids of 21%, using a Brookfield viscometer at 6 rpm using an LV spindle number 62 at 25° C.

8. The method of claim 1, wherein step (b) comprises adding the aldehyde acceptor to an intermediate polymer formulation having a content of aldehydes and ketones of from about 0.125% to about 0.25% by weight based on the amount of N-vinylcarboxamide monomers used in step (a), and wherein step (c) creates a vinylamine-containing polymer solution having a dynamic viscosity of from about 1000 cPs to about 2000 cPs, as measured with total solids of 21%, using a Brookfield viscometer at 6 rpm using an LV spindle number 62 at 25° C.

9. The method of claim 1, wherein step (b) comprises adding the aldehyde acceptor in an amount of from greater than 1.0% to about 1.75% by weight based on the amount of N-vinylcarboxamide monomers used in step (a).

10. The method of claim 1, wherein step (b) comprises adding the aldehyde acceptor in an amount of from about 1.15% to about 1.35% by weight based on the amount of N-vinylcarboxamide monomers used in step (a).

11. The method of claim 1, wherein adding an aldehyde acceptor in an amount of from greater than 1.0% to about 3.0% by weight based on the amount of N-vinylcarboxamide monomers used in step (a) comprises:
measuring the amount of aldehydes, ketones, and unreacted N-vinylcarboxamide monomers in the intermediate polymer formulation; and
adding an amount of the aldehyde acceptor such that the ratio of aldehyde acceptor to aldehydes, ketones, and unreacted N-vinylcarboxamide monomers in the intermediate polymer formulation is a predetermined weight ratio.

12. The method of claim 11, wherein the predetermined weight ratio is from about 0.5:1 to about 1.5:1.

13. The method of claim 11, wherein the predetermined weight ratio is from about 0.9:1 to about 1.1:1.

14. The method of claim 1, wherein the aldehyde acceptor is a bisulfite salt.

15. The method of claim 14, wherein the bisulfite salt is sodium bisulfite.

16. The method of claim 1, wherein step (a) comprises combining a polymerization initiator, a source of N-vinylcarboxamide monomers, and optionally a source of one or more additional vinyl monomers, wherein the source of N-vinylcarboxamide monomers has an N-vinylcarboxamide content of less than about 97% by weight based on a total weight of the source of N-vinylcarboxamide monomers; wherein step (b) comprises adding the aldehyde acceptor to an intermediate polymer formulation having a content of aldehydes and ketones of from about 0.075% to about 0.25% by weight based on the amount of N-vinylcarboxamide monomers used in step (a); and wherein step (c) comprises creating a vinylamine-containing polymer solution having a dynamic viscosity of from about 1000 cPs to about 2000 cPs, as measured with total solids of 21%, using a Brookfield viscometer at 6 rpm using an LV spindle number 62 at 25° C.

17. A polyvinylamine-containing polymer solution formed by:
(a) reacting a polymerization initiator, one or more N-vinylcarboxamide monomers, and optionally one or more additional vinyl monomers having a formula different from the N-vinylcarboxamide monomers, in a reaction mixture to create an intermediate polymer formulation comprising a poly(N-vinylcarboxamide) prepolymer, wherein the N-vinylcarboxamide monomers have the general formula I 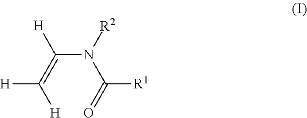
wherein R¹ and R², independently of one another, are H or C₁ to C₆ alkyl groups;
(b) adding an aldehyde acceptor in an amount of from greater than 1.0% to about 3.0% by weight based on the amount of N-vinylcarboxamide monomers used in step (a); and
(c) hydrolyzing carboxamide groups in the poly(N-vinylcarboxamide) prepolymer to create a vinylamine-containing polymer solution comprising a vinyl-amine containing polymer.
